(19) United States
(12) Patent Application Publication
(10) Pub. No.: US 2005/0028028 A1
(43) Pub. Date: Feb. 3, 2005

(54) Method for establishing a redundant array controller module in a storage array network

(76) Inventor: Mahmoud K. Jibbe, Wichita, KS (US)

Correspondence Address: LSI LOGIC CORPORATION, 1621 BARBER LANE, MS: D-106, MILPITAS, CA, 95035, US

(21) Appl. No.: 10/629,877

(22) Filed: Jul. 29, 2003

(51) Int. Cl. G06F 11/00

(52) U.S. Cl. 714/6

(57) ABSTRACT

The method establishes redundancy at the array controller module level. The redundancy is established via a state machine, which synchronizes, in lock step, the array controller modules and a switch in a quick loop topology (internal or external to the drive trays). The state machine provides the redundant array controller module multiple paths to the drive trays. These paths allow the redundant array controller the capability of taking over the I/O configuration and I/O access to the drive trays in the case of an array controller module failure (i.e., failover to the redundant array controller module).

### FIELD OF THE INVENTION

The present invention generally relates to the field of storage devices, and particularly to storage array network control.

### BACKGROUND OF THE INVENTION

In a Storage Array Network (SAN), an array controller module typically consists of two redundant array controllers. The two array controllers may be in dual active mode or active-standby mode. In both modes, if the active controller fails, then the other active array controller or the standby array controller assumes control over the failed active array controller responsibilities and activities (i.e., redundant operation).

The current array technology does not handle the following cases. 1) Controller module failure, which prevents both array controllers from accessing the drive trays. These failures may be related to power supply failures, fan failure, mid plane failure, and the like. 2) Active controller failure such that the alternate controller is prevented from accessing the drive trays. 3) Standby controller failure such that the active array controller is prevented from accessing the drive trays.

Therefore, it would be desirable to provide a system and method for ensuring the reliable operation of a storage array network.

### SUMMARY OF THE INVENTION

Accordingly, the present invention is directed to a system and a method to resolve the problems of the current art by isolating the failed array controller module and transferring the responsibilities and activities to the alternate array controller module without changing the hardware design of the existing array controller, but with the addition of an external or internal switch and a state machine for lock step synchronization between redundant alternate controller arrays.

In a first aspect of the present invention, a storage array network includes a first and second storage array controller module, wherein each storage array controller module has a first and second array controller unit and an array of storage devices. The first storage array controller module is a primary storage array controller module that normally performs storage array controller functions. The second storage array controller module is a redundant back up. The second array controller module provides an availability signal to the first storage array controller module and vice versa. If the primary array controller processes the command, the command is removed from secondary array controller module queue; thus, disabling processing of that command by the secondary array controller module. If the first array controller module does not process the command and if the second array controller module does not receive a signal from the first storage array controller module within a given period of time, the second storage array controller module asserts control over the array of storage devices.

In a second aspect of the present invention, a method for maintaining operation of a storage array network system includes various steps. One step is the submission of a command to a primary array controller module and a secondary array controller module. A following step is performing a handshaking protocol between the primary array controller module and the second array controller module to determine which of the primary and the second array controller modules is to process the command. Simultaneously, an aspect other command is timed.

The method of this invention contributes the following aspects to the state of the art. 1) Redundancy at the array controller module level provides recovery from the following failures: a. Controller module failure, which prevents both array controllers from accessing the drive trays (these failures can be related to power supply failures, fan failures, mid-plane failures, and other failures.); b. Active controller failures that prevent the alternate controller from accessing the drive trays; and c. standby controller failures that prevent the active array controller from accessing the drive trays. 2) An automatic method to transfer the volumes ownership from the primary array controller module to the secondary array controller module or vice versa without any user intervention. 3) Almost double the I/O throughput of an array system by using the bandwidth and the dual paths of the two redundant array controller modules.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 illustrates an embodiment of the storage array network system of the present invention;

FIG. 2 illustrates an embodiment of the general method of the present invention;

FIG. 3 illustrates the preferred embodiment of the method of the present invention; and

FIG. 4 illustrates an alternate embodiment of the method of the present invention.

### DETAILED DESCRIPTION OF THE INVENTION

Reference will now be made in detail to the presently preferred embodiments of the invention, examples of which are illustrated in the accompanying drawings.

The present invention relates to a method and system for preventing contention between array controller units and provides for effective bypassing of a defective array controller module. The present invention uses two (or more) array controller modules and a storage device array switch to switch between the outputs of the array controller modules. The method relies on handshaking protocol and a timing condition to bypass suspect, questionable, or bad commands or data from the host to the array controller modules.

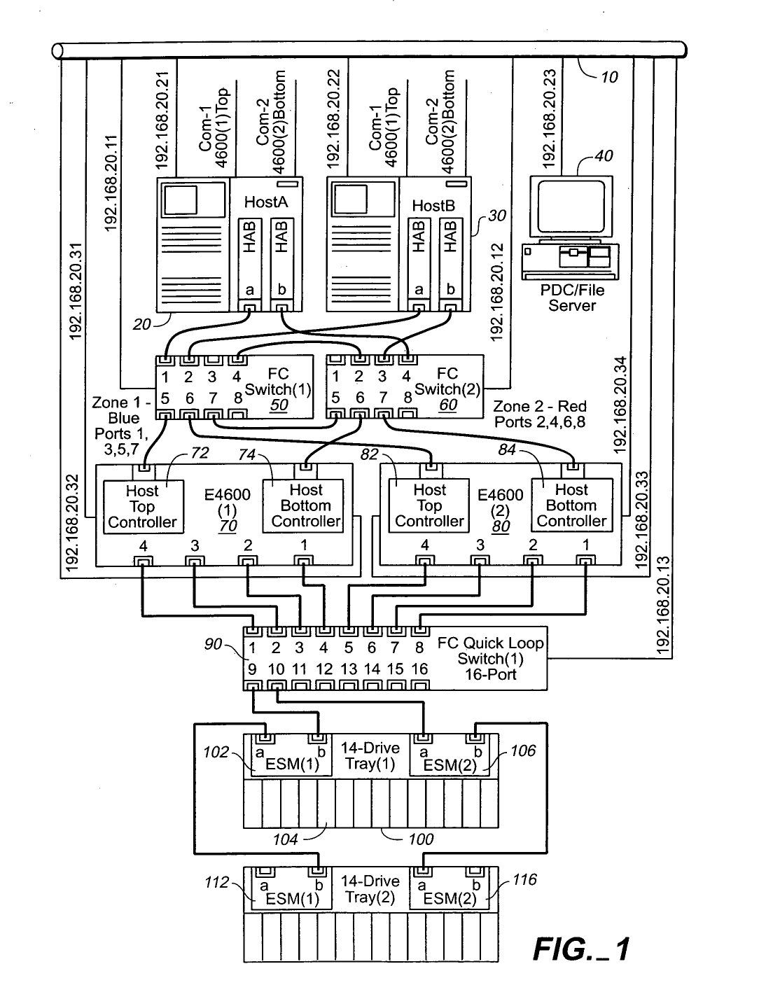

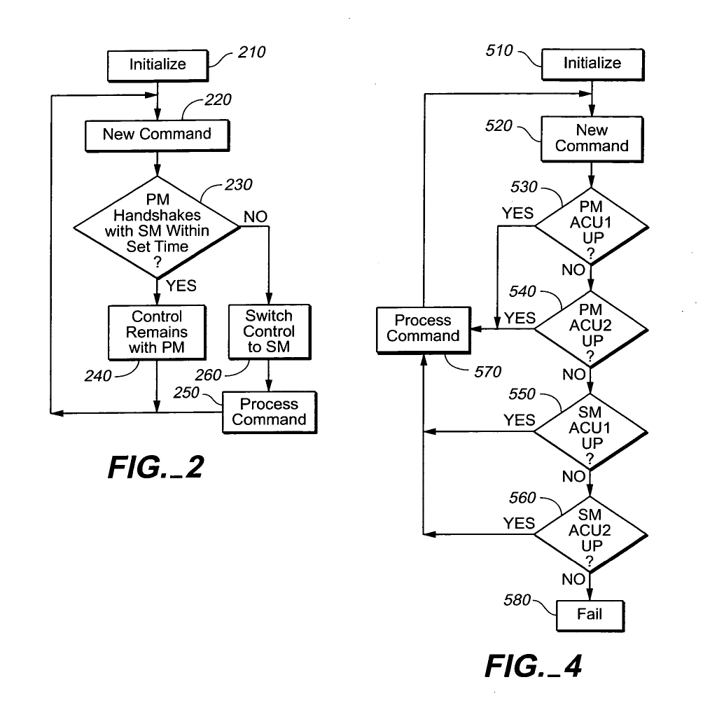

FIG. 1 illustrates an embodiment of a storage array network system of the present invention. The primary storage array controller module 70 mini hub 1 is connected to port 4 of the storage device array switch 90. As shown in FIG. 2, the storage array device array switch 90 receives eight inputs. The eight inputs represent the four combinations possible between the first (i.e., top) array controller units 72, 82 and the second (i.e., bottom) array controller units 74, 84. That is, a first combination is the pair of the top array controller unit 72 and bottom array controller unit 74 of the primary array controller module, a second combination of the top array controller unit 72 of the primary array controller module and the bottom controller 84 of the secondary array controller module, a third combination of the top array controller unit 82 of the secondary array controller module and the bottom array controller unit 74 of the primary array controller module, and a fourth combination of the top array controller unit 82 and the bottom array controller unit 84 of the secondary array controller module. Port 9 of the storage device array switch 90 is connected to port (b) of the Environmental Service Module 102 of the first tray 100. Port (a) of Environmental Service Module 102 of the first tray 100 is connected to port (b) of Environmental Service Module 112. Port (a) of the Environmental Service Module 106 is connected to port 10 of the storage device array switch 90. Port 8 of the storage device array switch 90 is connected to mini hub 1 of the secondary array controller module 80. These connections establish one loop with two redundant array controller module access to the bank of the drive trays. In a similar way, other loops may be implemented using other controllers. The mini hub connections provide the capability to practice the method of the present invention in which redundant paths/loops are provided to the bank of drive trays for two or more redundant array controller modules.

In a preferred embodiment of the present invention, array controller unit 72 and array controller unit 82 belong to the first multicast group. Array controller unit 74 and array controller unit 84 belong to the second multicast group. The multicast groups are required by the preferred embodiment of the method of the present invention because Host A and Host B broadcast any command (i.e., I/O “exchange data”—Originator Exchange Identity or OX_ID—or symbol command “array system configuration”) to the first multicast group array controller units and the second multicast group array controller units. In this way, the frames from the top and bottom array controller units of the primary array controller module are forwarded to the top and bottom array controller units of the second array controller module. Thus, if primary array controller module fails, the secondary array controller module assumes control of processing a command or operation. It is noted that the symbol command to configure the storage array network system may be sent from a client over the network or an agent over the Fibre Channel or Small Computer System Interface (SCSI) cable. In both media and networks, the broadcasting provides the redundant communication paths.

FIG. 2 illustrates an embodiment of the general method of the present invention. The storage array network system is initialized 210 in which a primary array controller module and at least one secondary array controller module are determined by the storage array network system. A user or manufacturer may set a preferred addressing scheme by DIP switches or the like. A module prioritization scheme or algorithm may be implemented as software or firmware code resident on one or more of the array controller modules. A command is issued from the host 220. The command is entered into a command queue in each of the array controller modules. The command queue may be implemented in software (e.g., in an array or table) or in hardware (e.g., in a first in first out memory device.) The primary array controller module (PM) and the second array controller module engage in a timed handshaking protocol 230. If the primary array controller module successfully handshakes with the second array controller module within a given time, the primary array controller module retains control of the command 240 and processes the command 250. In an embodiment, if the primary array controller module processes the command, the primary array controller module may remove the command (as by deleting from a queue) such that the secondary array controller module is prevented from assuming control even if the module handshaking protocol were to fail. In another embodiment, if the primary array controller module unsuccessfully handshakes with the secondary array controller module, the secondary array controller module assumes control for processing the command 260, 250. After the command is processed, a new command may be retrieved from the queue 220.

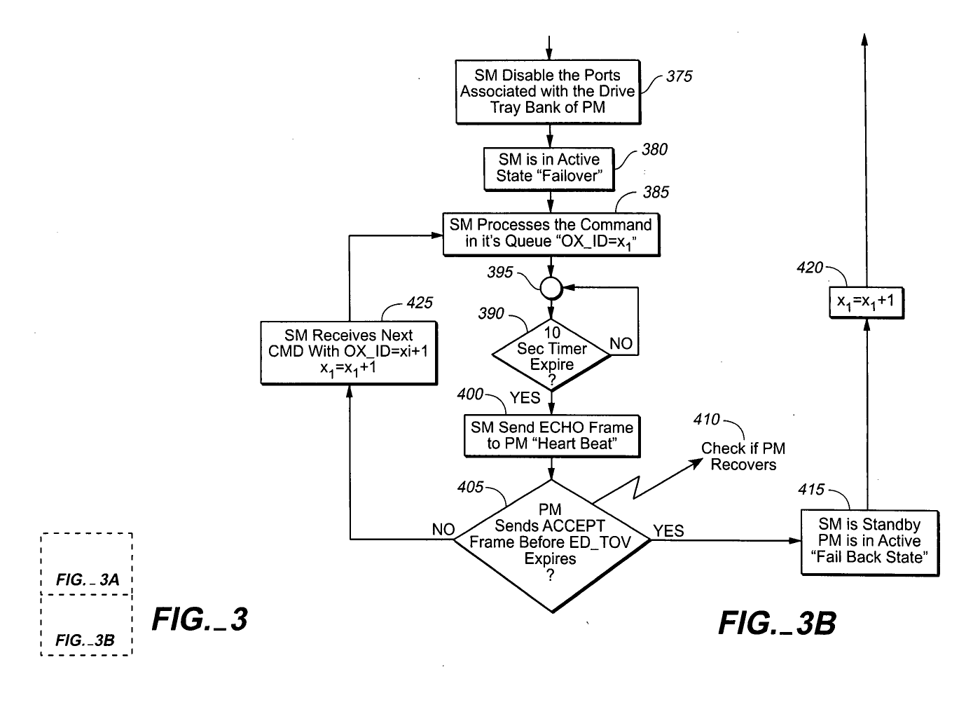

FIG. 3 illustrates a preferred embodiment of the method of the present invention. In the preferred method, the remedies for the following scenarios are described:

Case 1: Both array controller modules are healthy (Active-Standby mode). In this case, upon receiving a command, the primary array controller module (PM) sends an ECHO frame to the secondary array controller module (SM) 325 informing it that the command with the exchange ID is processed 335. The secondary array controller module sends an ACCEPT frame indicating the command with Exchange ID is dumped 335. In the mean time, the second array controller module periodically sends an ECHO frame to check the health of primary module. The primary array controller module sends an ACCEPT frame 370 to indicate good status. Thus, the primary and secondary array controller modules are synchronized in lock step in terms of processing commands. It is noted that the secondary array controller module monitors all the configurations and I/O access of the primary module (in a monitor state that is part of Standby mode).

Case 2: Both array controller modules are healthy (Active-Active mode). In this case, the host broadcast a command to both array controller modules. The array controller module that is capable of processing the command sends an ECHO frame to the other array controller module to inform it that the command with an exchange ID is being processed (e.g., cache flushing of the drive trays). The alternate array controller module sends an ACCEPT frame to remove the command with exchange ID from its queue 340. In this mode, the volume owner to be accessed gets transferred to the available array controller module without any user intervention and as a result the overall performance of the storage array network system is almost doubled.

Case 3: Primary array controller module fails and secondary array controller module assumes control. In this case, the secondary array controller module sends an ECHO frame to the primary array controller module 355, but does not receive an ACCEPT frame after Error Detection Timeout expires 370. The secondary array controller module disables the primary array controller module switch ports 375, namely ports 1, 2, 3, and 4. Regardless as to how the primary array controller module fails, the secondary array controller modules is still able to access the bank of drive trays. Then, the second array controller module completes any outstanding exchanges 385.

Case 4: Primary array controller module recovers and secondary array controller module fail backs. In this case, the primary array controller module comes online and sends ECHO frames to array controller units 400 of the second array controller module indicating the online state using the loop between hosts and array controller modules. The secondary array controller module processes any outstanding exchanges and returns ACCEPT frames 405 to the array controller units of the primary array controller module indicating a fail back state 415. Upon receiving the ACCEPT frames, the array controller units of the primary array controller module assume the responsibility of the processing exchanges 310.

Rules and states of the method of the present invention. The method of the present invention adopts the following rules/states for each mode of operation:

I. Active-Standby Mode

1) The primary (or, secondary) array controller module sending an ECHO frame to the secondary (or, primary) array controller module is equivalent to the first array controller unit of primary (or, secondary) array controller module sending an ECHO frame to the first array controller unit of the secondary (or, primary) array controller module and the second array controller unit of the primary (or, secondary) array controller module sending an ECHO frame to the second array controller unit of the secondary (or, primary) array controller module.

2) In the optimal state, the primary array controller module processes the commands while the secondary array controller module is in the standby state. In this state, the array controller units of primary array controller module return ECHO frames to the array controller units of secondary array controller module with ECHO data set to the healthy state.

3) In the standby state, the secondary array controller module sends an ECHO frame to the primary array controller module and receives an ACCEPT frame before the Error Detection Time Out Value (ED-TOV), which is 2 seconds, expires. The Error Detection Time Out Value may be made adjustable to another period of time from 0.5 to 60 seconds (e.g., 5 seconds) or some other value.

4) The primary (or, secondary) array controller module fails or is in the failed state if the array controller units of the primary (or, secondary) array controller module do not return an ACCEPT frame to the secondary (or, primary) array controller module with the ECHO data set to a healthy state.

5) The primary (or, secondary) array controller module is degraded or in the degraded state if the array controller units of the primary array (or, secondary) array controller module do not return an ACCEPT frame to the secondary (or, primary) array controller module with the ECHO data set to a healthy state.

6) In the fail back state, the secondary array controller module sends an ECHO frame to the primary array controller module and receives an ACCEPT frame before the Error Detection Time Out Value (ED-TOV), which is 2 seconds, expires (as noted, this time period may be made adjustable). In this transition state, the primary array controller module transfers to the optimal or degraded state and starts processing the commands.

II. Active-Active Mode

1) The primary (or, secondary) array controller module sending an ECHO frame to the secondary array (or, primary) array controller module is equivalent to the first array controller unit of the primary (or, secondary) array controller module sending an ECHO frame to the first array controller unit of the secondary (or, primary) array controller module and the second array controller unit of the secondary (or, primary) array controller module sending an ECHO frame to the second array controller unit of primary (or, secondary) array controller module.

2) If the primary (or, secondary) array controller module has all the resources to process a command, then the secondary (or, primary) array controller module sends an ECHO frame to the primary (or, secondary) array controller module with the ECHO data indicating that processing command with OX-ID xi and the secondary (or, primary) array controller module yields and sends an ACCEPT frame indicating that the secondary (or, primary) array controller module is removing the command with OX-ID xi from its queue. This is an implicit AutoVolume Ownership Transfer—a feature of the LSI RAID system. In the case of a race condition (i.e., both array controller modules sending the ECHO frame for a particular command), the primary array controller module has higher priority in processing the command than does the secondary array controller module. That is, if both modules receive an ECHO frame for the same command, then the secondary array controller module yields and sends the ACCEPT frame.

The present method handles caching. In the preferred embodiment, if an array controller module is caching data, then the two array controller modules must be in the Active-Active mode. Thus, if one of the array controller modules caches data for particular exchanges and one of its controllers or the entire module fails, then the redundant array controller unit of the other array controller module flushes its data to the drive bank from its cache because the original exchange was forwarded to the first array controller units and the second array controller units of both array controller modules. Therefore, the redundant array controller module arrangement handles caching by exchange broadcasting and by the monitoring activities between the multicast groups of both array controller modules.

The broadcasting exchanges between array controller units of the present method do not require additional bandwidth from the host because multicasting is built into the different network protocols (i.e., Gigabit Ethernet, Fibre Channel, FCIP, IFCP, SCSI, ISCSI, SAS, or others). Therefore, there is very small overhead to synchronize, in lock step, the array controller units of both array controller modules.

The preferred embodiment of the method of the present invention permits the two array controller modules to present their information back to the host according to the mode of operation. In the Active-Standby case, only the active array controller module presents information from its array controller units to the host. In the case where the first array controller module fails, the standby module disables first array controller module ports, becomes active, goes through the rest of the cycle, presents information from its array controller units to the host, and then processes the exchange. In the Active-Active state, both array controller modules present information from their array controller units to the host adapters but because the array controller units have multicast addresses, the host adapter presents the primary array controller module array controller units to the operating system. This aspect is built in the protocol. In the case where the primary array controller module fails, the alternate module (i.e., the secondary array controller module) disables the ports for the primary array controller module, becomes active, passes through a rest cycle, presents its array controller units to the host, and then processes the exchange.

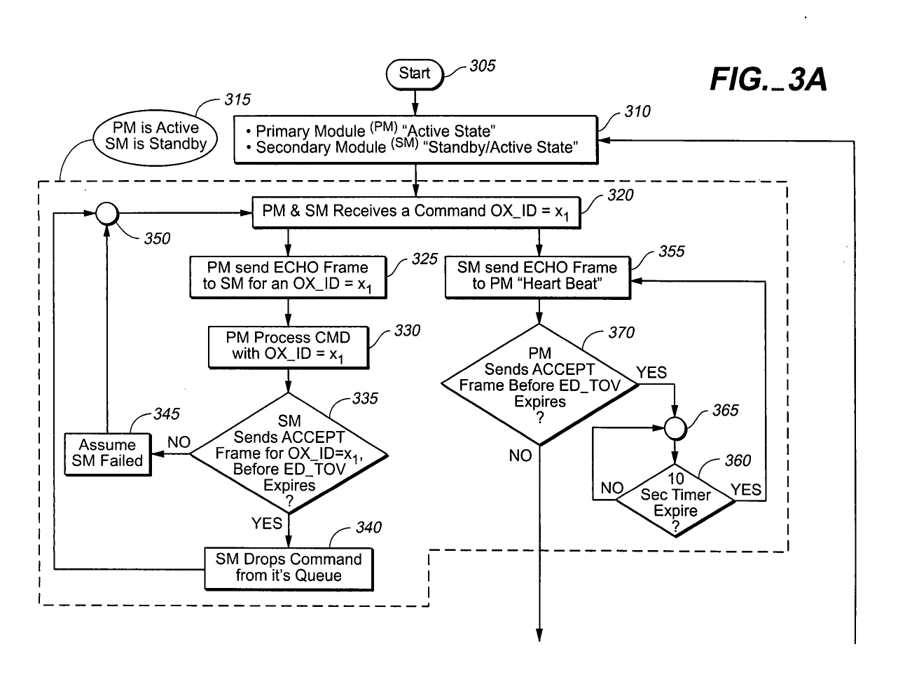

FIG. 4 illustrates an alternative embodiment of the method of the present invention. The storage array network system is initialized 510. A new command is sent by a host 520. The array controller units are prioritized such that the new command is processed 570 by the first array controller unit (i.e., the first array controller unit of the primary array controller module) if the first array controller unit is active and healthy 540. If not, if the second array controller unit of the primary array controller module is available 540, the second array controller unit processes the command 570. If neither the first or second array controller units of the primary array controller module are available, then the first array controller unit of the secondary array controller module is checked for availability 550. Finally, the second array controller unit of the secondary array controller module may be checked 560. If it is not determined to be active and healthy, the process fails 580. Failure may be indicated by a message on a graphical user interface of a display, by a visual indicator, and/or by an audible alarm. A timer or plurality of timers may be used to form wait loops as needed or to set time out conditions.

Other variations of the system and/or method may be implemented. For example, although array controller modules may be treated as a unit, the array controller units may be implemented in a mix or match arrangement such that one array controller unit from a array controller module may be functionally paired with an array controller unit from another array controller module. As another example, one array controller unit may be dedicated to a one way data flow to the array controller module and another array controller unit may be dedicated to one way data flow from the array controller module. The system may be implemented such that any one of four array controller units is arranged to handle all the commands (in accordance with FIG. 4).

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages, the form hereinbefore described being merely an explanatory embodiment thereof. It is the intention of the following claims to encompass and include such changes.

1. A storage array network, comprising:
a first and second storage array controller module, wherein each storage array controller module has a first and second array controller unit; and
an array of storage devices,
wherein the first storage array controller module is a primary storage array controller that normally performs storage array controller functions and the second storage array controller module is a redundant back up,
wherein the second array controller module provides an availability signal to the second storage array controller module,
wherein if the second array controller module does not receive a signal from the first storage array controller module within a given period of time, the second storage array controller module asserts control over the array of storage devices.

2. The storage array network of claim 1, further comprising a storage array switch electrically connected between the first and second storage array controller modules and the array of storage devices.

3. The storage array network of claim 2, wherein the storage array switch is a Fibre Channel quick loop switch.

4. The storage array network of claim 1, further comprising first and second interface switches and first and second host devices electrically connectable to the first and second storage array controller modules through the first and second interface switches.

5. The storage array network of claim 1, wherein the first array controller units of the first and second storage array controller modules are grouped together into a first multicast group.

6. The storage array network of claim 5, wherein a host broadcasts a command to the first multicast group.

7. The storage array network of claim 6, wherein frames for the first array controller unit of the first storage array controller module are forwarded to the first array controller unit of the second storage array controller module.

8. The storage array network of claim 1, wherein redundancy and drive control is accomplished through multiple storage array controller modules.

9. The storage array network of claim 1, wherein, if one of the storage array controller modules fails, another storage array controller module assumes control.

10. A method for maintaining operation of a storage array network system, comprising:
submitting a command to a primary array controller module and a secondary array controller module;
performing a handshaking protocol between the primary array controller module and the second array controller module to determine which of the primary and the second array controller modules is to process the command; and
timing of an aspect of the command.

11. The method of claim 10, wherein the step of performing a handshaking protocol includes the substeps of, if the primary array controller module is able, sending a primary module ready signal to the secondary array controller module;
if the secondary array controller module is able, sending a secondary module ready signal to the primary array controller module; and
if the primary array controller module is able, processing the command before an expiration of a given time.

12. The method of claim 11, wherein the step of performing a handshaking protocol includes the substeps of if the primary array controller module is able, sending a primary module acknowledge signal to the secondary array controller module upon receipt of the secondary module ready signal.

13. The method of claim 12, wherein the step of performing a handshaking protocol includes the substeps of removing the command from a queue of the secondary array controller module.

14. The method of claim 13, wherein the step of performing a handshaking protocol includes the substep of disabling ports associated with a drive tray bank associated with the primary array controller module.

15. The method of claim 10, wherein if the primary array controller module successfully handshakes with the secondary array controller module within a given time, the primary array controller module processes the command.

16. The method of claim 15, wherein if the secondary array controller module unsuccessfully handshakes with the secondary array controller module within a given time, the secondary array controller module processes the command.

17. The method of claim 10, wherein when the timing reaches a time limit, processing of the command is performed by the secondary array controller module.

18. The method of claim 17, wherein the time limit is measured from a time of transmission of the command from a host.

19. The method of claim 18, wherein the command is transmitted from the host through an interface switch to the primary and secondary array controller modules.

20. The method of claim 10, wherein redundancy and drive control is accomplished through multiple storage array controller modules.

21. The method of claim 19, wherein, if one of the storage array controller modules fails, another storage array controller module assumes control.

22. A method for establishing a redundant array controller module in a storage array network, comprising:
receiving a command by primary and secondary array controller modules from a host;
storing the command within two queues, each of the queues being associated with one of the primary and secondary array controller modules;
if the primary array controller module processes the command before a time out, then removing the command from the queue of the secondary array controller module; and
if the primary array controller module times out, then processing the command by the secondary array controller module.

23. The method of claim 22, wherein both the primary and secondary array controller modules are in active mode.

24. The method of claim 22, wherein one of the primary and secondary array controller modules is in standby mode.

25. The method of claim 22, wherein, if the primary array controller module times out, the secondary array controller module disables ports associated with a drive tray bank of the primary array controller module.

26. The method of claim 22, wherein redundancy and drive control is accomplished through multiple storage array controller modules.

27. The method of claim 22, wherein, if one of the storage array controller modules fails, another storage array controller module assumes control.
